(19) United States
(12) Patent Application Publication
(10) Pub. No.: US 2012/0211478 A1
(43) Pub. Date: Aug. 23, 2012

(54) Multiple laser machining at different angles

(76) Inventors: Andrea Massa, Berlin (DE); Torsten MELZER-JOKISCH, Neuenhagen bei Berlin (DE); Andreas OPPERT, Falkensee (DE); Dimitrios THOMAIDIS, Berlin (DE)

(21) Appl. No.: 13/371,549

(22) Filed: Feb. 13, 2012

(30) Foreign Application Priority Data
Feb. 14, 2011 (EP) EP11154361

(51) Int. Cl. B23K 26/00

(52) U.S. Cl. 219/121.69

(57) ABSTRACT

A process using a single millisecond laser is presented. The process is traversed over the surface of a component a number of times. The tilt angle of the laser beam with respect to a drilling axis during a subsequent traverse is different from the tilt angle with respect to the drilling axis during the first traverse of the surface. By using the single millisecond laser which although producing rougher surfaces than other millisecond lasers has higher material-removal rates, repeated traverses using different process parameters allow millisecond lasers to be successfully used to produce smooth surfaces.

### CROSS REFERENCE TO RELATED APPLICATIONS

This application claims priority of European Patent Office application No. 11154361.EP filed Feb. 14, 2011. All of the applications are incorporated by reference herein in their entirety.

### FIELD OF INVENTION

The invention relates to a process for laser drilling, wherein a laser is passed over the surface to be machined a number of times and in the process various angles are set.

In many components, in particular cast components, areas of removed material, such as recesses or through-holes, have to be produced retrospectively. In particular in the case of turbine components which have film-cooling holes for cooling purposes, holes are introduced retrospectively after the component has been produced. Such turbine components, or indeed components for high-temperature applications in general, often also have layer coatings, such as for example a metallic layer and/or a ceramic outer layer. The film-cooling holes then have to be produced through the layers of the substrate (casting). Equally, such coated components are refurbished after use and provided with new layers, during which stage the interior of the through-holes is also coated (coat down), and this material then has to be removed again. This involves considerable work with expensive equipment and complex processes.

### SUMMARY OF INVENTION

Therefore, it is an object of the invention to provide a process allowing the process to be carried out quickly and inexpensively.

EP 1 681 128 A1 shows a laser drilling process in which a diffuser of a film-cooling hole is produced in meandering form.

The object is achieved by a process as claimed in the claims.

The dependent claims list further advantageous measures which can be combined with one another as desired, in order to obtain further advantages.

### BRIEF DESCRIPTION OF THE DRAWINGS

In the drawings:

FIGS. 1, 2, 3 show views of a film-cooling hole in various perspectives;

FIGS. 4-11 show process steps of a laser drilling process;

FIG. 12 shows a turbine blade or vane;

FIG. 13 shows a combustion chamber;

FIG. 14 shows a gas turbine;

FIG. 15 shows a list of superalloys.

The figures and the description represent only examples of the invention.

### DETAILED DESCRIPTION OF INVENTION

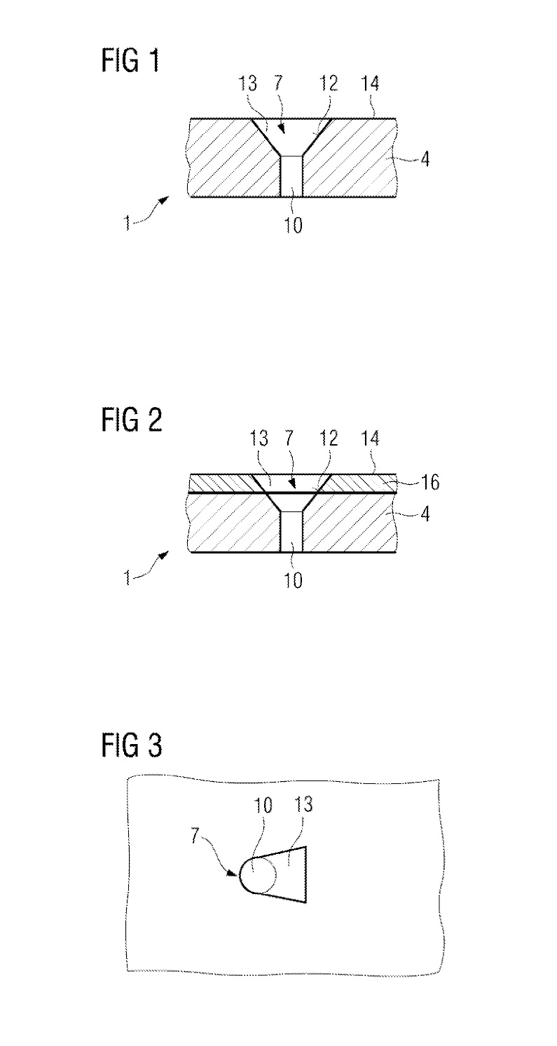

FIG. 1 shows a component 1 with a hole 7.

The component 1 comprises a substrate 4 (for example a casting or DS or SX component).

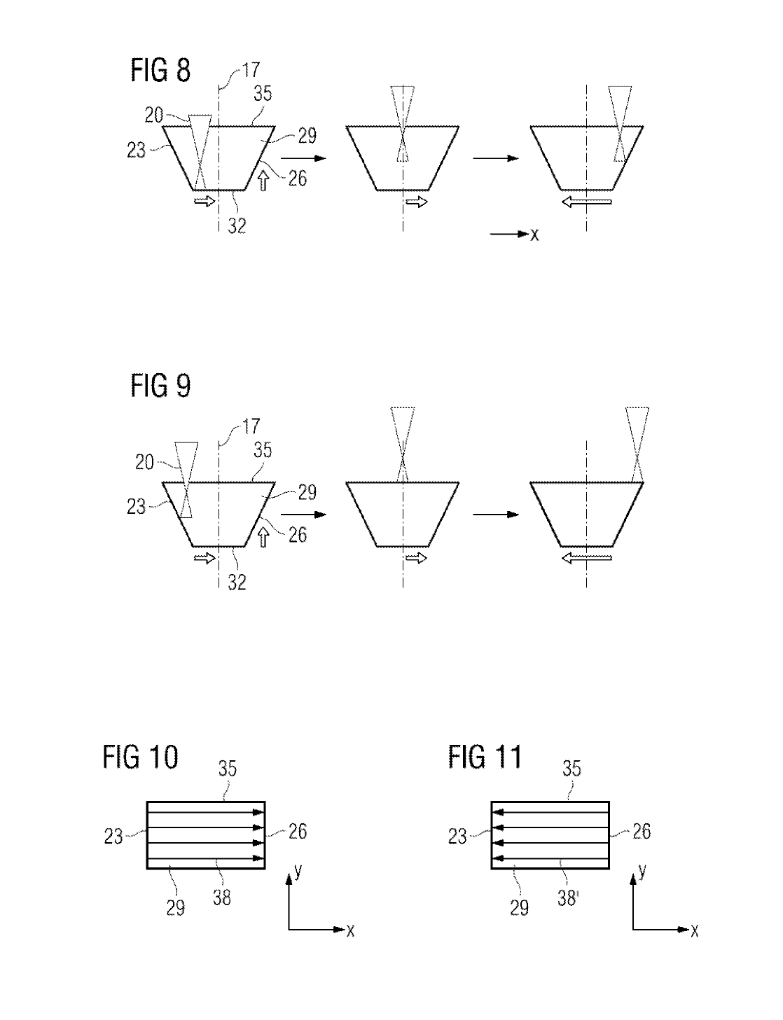

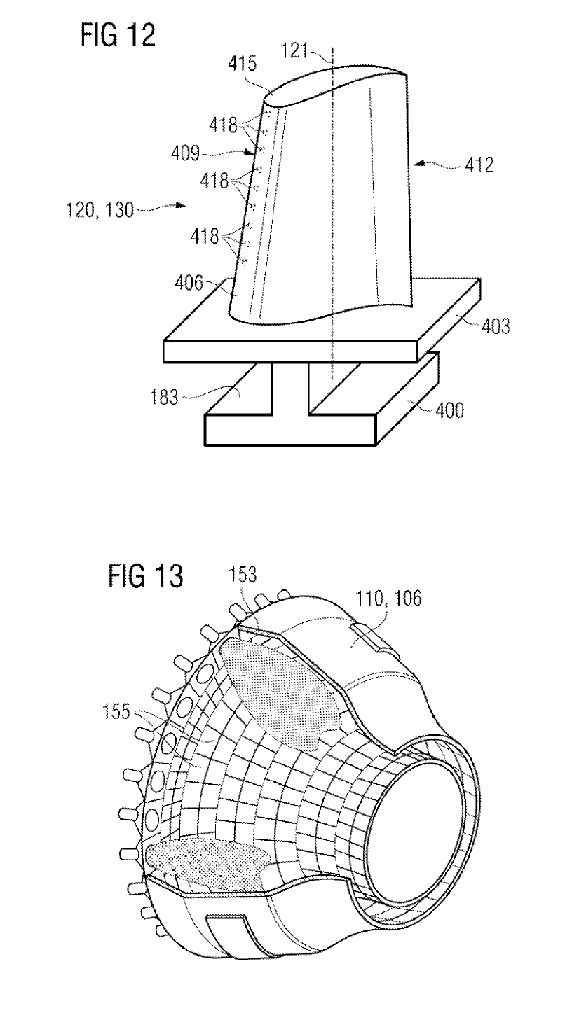

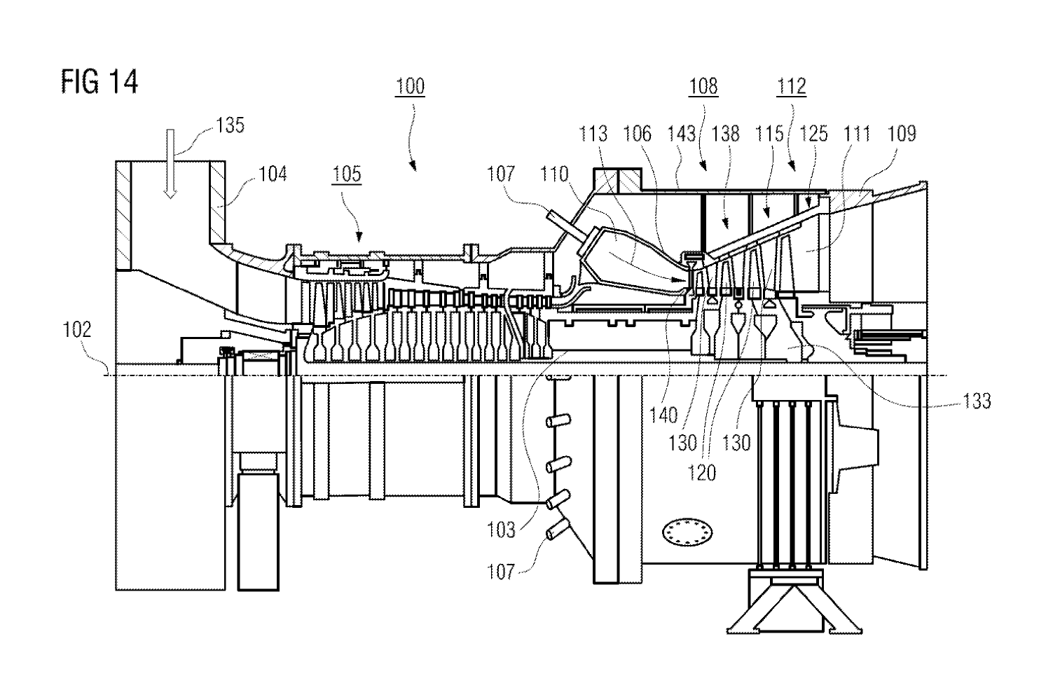

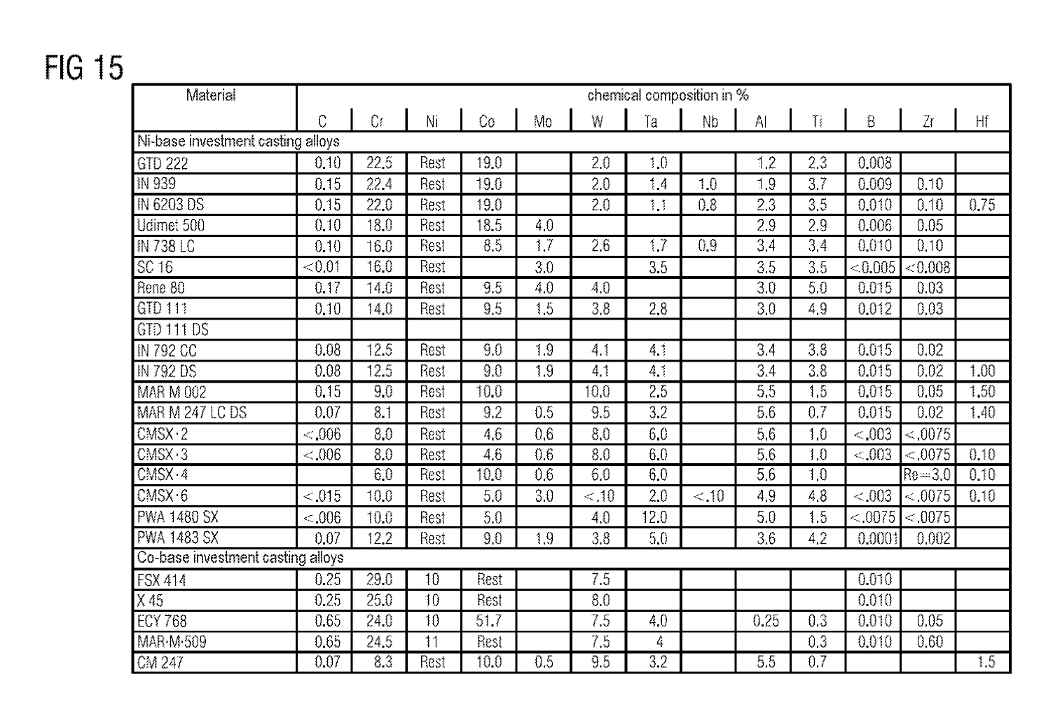

The substrate 4 may be metallic and/or ceramic. In particular in the case of turbine components, such as for example turbine rotor blades 120 or guide vanes 130 (FIG. 12), heat shield elements 155 (FIG. 13) and other casing parts of a steam or gas turbine 100 (FIG. 14), but also of an aircraft turbine, the substrate 4 consists of a nickel-, cobalt- or iron-based superalloy (FIG. 15). In the case of turbine blades or vanes for aircraft, the substrate 4 consists for example of titanium or a titanium-base alloy.

The substrate 4 has a hole 7, for example a through-hole. However, it may also be a blind hole.

The hole 7 comprises a lower region 10, which starts from an inner side of the component 1 and is for example symmetrical (for example circular, oval or rectangular) in form, and an upper region 13, which if appropriate is formed as a diffuser 13 at an outer surface 14 of the substrate 4. The diffuser 13 constitutes a widening of the cross section compared to the lower region 10 of the hole 7.

The hole 7 is for example a film-cooling hole. In particular the inner surface 12 of the diffuser 30, i.e. in the upper region of the hole 7, is supposed to be smooth, because unevenness causes undesirable turbulence and diversions, in order to allow optimum flow of a medium, in particular a cooling medium, out of the hole 7. Much lower demands are placed on the quality of the hole surface in the lower region 10 of the hole 7, since this has much less effect on the flow characteristics.

FIG. 2 shows a component 1 which is designed as a layer system.

At least one layer 16 is present on the substrate 4. This may for example be a metal alloy of the MCrAlX type, where M stands for at least one element selected from the group consisting of iron, cobalt or nickel. X stands for yttrium and/or at least one rare earth element.

The layer 16 may also be ceramic.

A further layer (not shown), for example a ceramic layer, in particular a thermal barrier coating, may also be present on the MCrAlX layer.

The thermal barrier coating is for example a fully or partially stabilized zirconium oxide layer, in particular an EB-PVD layer or a plasma-sprayed (APS, LPPS, VPS), HVOF or CGS (cold gas spraying) layer.

A hole 7 comprising the lower region 10 and the diffuser 13 is also introduced into this layer system 1.

The statements made above in connection with the production of the hole 7 are applicable to substrates 4 with or without layer 16 or layers 16.

FIG. 3 shows a plan view of a hole 7.

The lower region 10 could be produced by a material-removing manufacturing process. By contrast, this would be impossible, or at least only possible at considerable outlay, for the diffuser 13.

The hole 7 may also run at an acute angle to the surface 14 of the component 1.

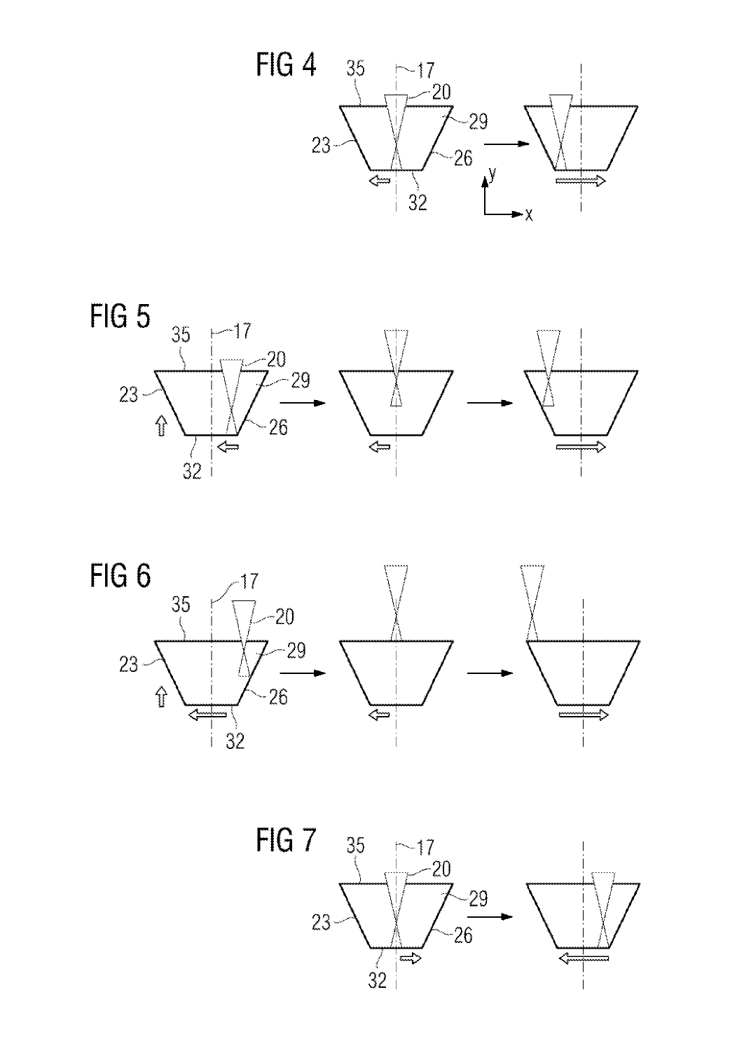

FIG. 4 shows the start of the material-removal process (machining) of a surface 29.

The surface 29 that is to be machined has a trailing edge 32 and an opposite end side 35 (Y direction) with two sides 23, 26 (X direction). Similar conditions apply analogously for triangular, polygonal or round surfaces.

At the start of the material-removal process, the laser beam 20 is preferably centered preferably on the middle of the trailing edge 32 of the surface 29 that is to be machined and is preferably defocused above the material-removal plane.

When first starting up, the laser beam 20 is preferably tilted with respect to the drilling axis 17, very particularly preferably by 2°. The drilling axis 17 is preferably an axis of symmetry of the hole 7 or of a symmetrical region of the hole 7. In the case of a hole as shown in FIGS. 2, 3, this is the axis of symmetry of the lower region 10. The laser beam 20 is preferably tilted with respect to an end side 32, 35, i.e. preferably perpendicular to the direction of traverse.

Then, the laser (OFF) is moved in the X direction to a first side 23.

Then, the laser material-removal process starts (laser ON) from the first side 23 toward a second side 26.

When the side 26 of the surface 29 that is to be machined has been reached, the laser is switched off.

In the next step as shown in FIG. 5, the laser is moved with the control system, in particular a CNC machine, in the X direction in the direction of the first side 23, preferably to the center of the hole, for preference to the same point (FIG. 4 left) as at the start of the process, and the laser is shifted one line width in the Y direction (toward the end side 35).

Then, as shown in FIG. 4 left, the laser is moved back in the X direction toward the first side 23 (laser OFF), so that from there (laser ON) laser beams once again machine the surface 29 from the side 23 to the other side 26.

Depending on the size of the surface 29 that is to be machined, the traverse, i.e. FIGS. 4, 5, is repeated until the other end side 35 (the opposite side from the trailing edge 32) has been reached through displacement of the Y direction of the surface 29 that is to be machined, as shown in FIG. 6.

FIG. 10 shows the beam path of the laser beam 20 on the surface 29.

The laser beam 20 is preferably always moved only from one side 23 in the X direction toward the other side 26, i.e. the laser is switched off when the laser position is being returned to the side 23.

This represents a further invention, independent of the tilting of the laser beam 20, but is preferably combined with that of the tilting of the laser beam 20.

In FIGS. 7 to 9, the same surface is machined again, starting in the same way as in FIGS. 4 and 5, 6, but preferably with an increased tilt angle with respect to the drilling axis 17.

Preferably, during the second traverse over the surface 29 the laser beam 20 is always moved over the surface 29 from the other, second side 26 (laser) and not from the first side 23 as in the first traverse of the surface (FIG. 11).

This may even be repeated a third time, in which case the tilting angle is preferably increased further and the laser beam 20 is preferably always moved from the other side 23 again.

The multiple traverse over the surface 29 that is to be machined results in a smoothing if an excessively rough surface or melted zones were present during the first pass. This applies in particular for the removal of material from a hole.

In particular, low laser energies are used here, in particular of two joules.

Another advantage is that only one laser, in particular a single laser, is used, and in particular this is a millisecond laser, in particular with a pulse duration of 0.25 ms, to machine the component 1, and no further lasers are required.

If the process is used to remove “coat down”, it is preferable for a hole to be introduced in the “coat down” in the hole 7 that has already been produced prior to the machining of the surface 29.

FIG. 12 shows a perspective view of a rotor blade 120 or guide vane 130 of a turbomachine, which extends along a longitudinal axis 121.

The turbomachine may be a gas turbine of an aircraft or of a power plant for generating electricity, a steam turbine or a compressor.

The blade or vane 120, 130 has, in succession along the longitudinal axis 121, a securing region 400, an adjoining blade or vane platform 403 and a main blade or vane part 406 and a blade or vane tip 415.

As a guide vane 130, the vane 130 may have a further platform (not shown) at its vane tip 415.

A blade or vane root 183, which is used to secure the rotor blades 120, 130 to a shaft or a disk (not shown), is formed in the securing region 400.

The blade or vane root 183 is designed, for example, in hammerhead form. Other configurations, such as a fir-tree or dovetail root, are possible.

The blade or vane 120, 130 has a leading edge 409 and a trailing edge 412 for a medium which flows past the main blade or vane part 406.

In the case of conventional blades or vanes 120, 130, by way of example solid metallic materials, in particular superalloys, are used in all regions 400, 403, 406 of the blade or vane 120, 130.

Superalloys of this type are known, for example, from EP 1 204 776 B1, EP 1 306 454, EP 1 319 729 A1, WO 99/67435 or WO 00/44949.

The blade or vane 120, 130 may in this case be produced by a casting process, by means of directional solidification, by a forging process, by a milling process or combinations thereof.

Workpieces with a single-crystal structure or structures are used as components for machines which, in operation, are exposed to high mechanical, thermal and/or chemical stresses.

Single-crystal workpieces of this type are produced, for example, by directional solidification from the melt. This involves casting processes in which the liquid metallic alloy solidifies to form the single-crystal structure, i.e. the single-crystal workpiece, or solidifies directionally.

In this case, dendritic crystals are oriented along the direction of heat flow and form either a columnar crystalline grain structure (i.e. grains which run over the entire length of the workpiece and are referred to here, in accordance with the language customarily used, as directionally solidified) or a single-crystal structure, i.e. the entire workpiece consists of one single crystal. In these processes, a transition to globular (polycrystalline) solidification needs to be avoided, since non-directional growth inevitably forms transverse and longitudinal grain boundaries, which negate the favorable properties of the directionally solidified or single-crystal component.

Where the text refers in general terms to directionally solidified microstructures, this is to be understood as meaning both single crystals, which do not have any grain boundaries or at most have small-angle grain boundaries, and columnar crystal structures, which do have grain boundaries running in the longitudinal direction but do not have any transverse grain boundaries. This second form of crystalline structures is also described as directionally solidified microstructures (directionally solidified structures).

Processes of this type are known from U.S. Pat. No. 6,024,792 and EP 0 892 090 A1.

The blades or vanes 120, 130 may likewise have coatings protecting against corrosion or oxidation e.g. (MCrAlX; M is at least one element selected from the group consisting of iron (Fe), cobalt (Co), nickel (Ni), X is an active element and stands for yttrium (Y) and/or silicon and/or at least one rare earth element, or hafnium (HI)). Alloys of this type are known from EP 0 486 489 B1, EP 0 786 017 B1, EP 0 412 397 B1 or EP 1 306 454 A1.

The density is preferably 95% of the theoretical density.

A protective aluminum oxide layer (TGO=thermally grown oxide layer) is formed on the MCrAlX layer (as an intermediate layer or as the outermost layer).

The layer preferably has a composition Co-30 Ni-28 Cr-8 Al-0.6 Y-0.7 Si or Co-28 Ni-24 Cr-10 Al-0.6 Y. In addition to these cobalt-based protective coatings, it is also preferable to use nickel-based protective layers, such as Ni-10 Cr-12 Al-0.6 Y-3 Re or Ni-12 Co-21 Cr-11 Al-0.4 Y-2 Re or Ni-25 Co-17 Cr-10 Al-0.4 Y-1.5 Re.

It is also possible for a thermal barrier coating, which is preferably the outermost layer and consists for example of ZrO₂, Y₂O₃—ZrO₂, i.e. unstabilized, partially stabilized or fully stabilized by yttrium oxide and/or calcium oxide and/or magnesium oxide, to be present on the MCrAlX.

The thermal barrier coating covers the entire MCrAlX layer.

Columnar grains are produced in the thermal barrier coating by suitable coating processes, such as for example electron beam physical vapor deposition (EB-PVD).

Other coating processes are possible, for example atmospheric plasma spraying (APS), LPPS, VPS or CVD. The thermal barrier coating may include grains that are porous or have micro-cracks or macro-cracks, in order to improve the resistance to thermal shocks. The thermal barrier coating is therefore preferably more porous than the MCrAlX layer.

Refurbishment means that after they have been used, protective layers may have to be removed from components 120, 130 (e.g. by sand-blasting). Then, the corrosion and/or oxidation layers and products are removed. If appropriate, cracks in the component 120, 130 are also repaired. This is followed by recoating of the component 120, 130, after which the component 120, 130 can be reused.

The blade or vane 120, 130 may be hollow or solid in form.

If the blade or vane 120, 130 is to be cooled, it is hollow and may also have film-cooling holes 418 (indicated by dashed lines).

FIG. 13 shows a combustion chamber 110 of a gas turbine. The combustion chamber 110 is configured, for example, as what is known as an annular combustion chamber, in which a multiplicity of burners 107, which generate flames 156, arranged circumferentially around an axis of rotation 102 open out into a common combustion chamber space 154. For this purpose, the combustion chamber 110 overall is of annular configuration positioned around the axis of rotation 102.

To achieve a relatively high efficiency, the combustion chamber 110 is designed for a relatively high temperature of the working medium M of approximately 1000° C. to 1600° C. To allow a relatively long service life even with these operating parameters, which are unfavorable for the materials, the combustion chamber wall 153 is provided, on its side which faces the working medium M, with an inner lining formed from heat shield elements 155.

On the working medium side, each heat shield element 155 made from an alloy is equipped with a particularly heat-resistant protective layer (MCrAlX layer and/or ceramic coating) or is made from material that is able to withstand high temperatures (solid ceramic bricks).

These protective layers may be similar to the turbine blades or vanes, i.e. for example MCrAlX: M is at least one element selected from the group consisting of iron (Fe), cobalt (Co), nickel (Ni), X is an active element and stands for yttrium (Y) and/or silicon and/or at least one rare earth element or hafnium (Hf). Alloys of this type are known from EP 0 486 489 B1, EP 0 786 017 B1, EP 0 412 397 B1 or EP 1 306 454 A1.

It is also possible for a, for example, ceramic thermal barrier coating to be present on the MCrAlX, consisting for example of ZrO₂, Y₂O₃—ZrO₂, i.e. unstabilized, partially stabilized or fully stabilized by yttrium oxide and/or calcium oxide and/or magnesium oxide.

Columnar grains are produced in the thermal barrier coating by suitable coating processes, such as for example electron beam physical vapor deposition (EB-PVD).

Other coating processes are possible, for example atmospheric plasma spraying (APS), LPPS, VPS or CVD. The thermal barrier coating may include grains that are porous or have micro-cracks or macro-cracks, in order to improve the resistance to thermal shocks.

Refurbishment means that after they have been used, protective layers may have to be removed from heat shield elements 155 (e.g. by sand-blasting). Then, the corrosion and/or oxidation layers and products are removed. If appropriate, cracks in the heat shield element 155 are also repaired. This is followed by recoating of the heat shield elements 155, after which the heat shield elements 155 can be reused.

Moreover, a cooling system may be provided for the heat shield elements 155 and/or their holding elements, on account of the high temperatures in the interior of the combustion chamber 110. The heat shield elements 155 are then, for example, hollow and may also have cooling holes (not shown) opening out into the combustion chamber space 154.

FIG. 14 shows, by way of example, a partial longitudinal section through a gas turbine 100.

In the interior, the gas turbine 100 has a rotor 103 with a shaft 101 which is mounted such that it can rotate about an axis of rotation 102 and is also referred to as the turbine rotor.

An intake housing 104, a compressor 105, a, for example, toroidal combustion chamber 110, in particular an annular combustion chamber, with a plurality of coaxially arranged burners 107, a turbine 108 and the exhaust-gas housing 109 follow one another along the rotor 103.

The annular combustion chamber 110 is in communication with a for example annular hot gas duct 111. There, for example four series-connected turbine stages 112 form the turbine 108.

Each turbine stage 112 is formed, for example, from two blade or vane rings. As seen in the direction of flow of a working medium 113, in the hot gas duct 111 a row of guide vanes 115 is followed by a row 125 formed from rotor blades 120.

The guide vanes 130 are secured to an inner housing 138 of a stator 143, whereas the rotor blades 120 of a row 125 are fitted to the rotor 103 for example by means of a turbine disk 133.

A generator (not shown) is coupled to the rotor 103.

While the gas turbine 100 is operating, the compressor 105 sucks in air 135 through the intake housing 104 and compresses it. The compressed air provided at the turbine-side end of the compressor 105 is passed to the burners 107, where it is mixed with a fuel. The mix is then burnt in the combustion chamber 110, forming the working medium 113. From there, the working medium 113 flows along the hot gas duct 111 past the guide vanes 130 and the rotor blades 120. The working medium 113 expands at the rotor blades 120, imparting its momentum, so that the rotor blades 120 drive the rotor 103 and the latter drives the generator coupled to it.

While the gas turbine 100 is operating, the components which are exposed to the hot working medium 113 are subject to thermal stresses. The guide vanes 130 and rotor blades 120 of the first turbine stage 112, as seen in the direction of flow of the working medium 113, together with the heat shield elements which line the annular combustion chamber 110, are subject to the highest thermal stresses.

To be able to withstand the temperatures which prevail there, they may be cooled by means of a coolant.

Substrates of the components may likewise have a directional structure, i.e. they are in single-crystal form (SX structure) or have only longitudinally oriented grains (DS structure).

By way of example, iron-based, nickel-based or cobalt-based superalloys are used as material for the components, in particular for the turbine blade or vane 120, 130 and components of the combustion chamber 110.

Superalloys of this type are known, for example, from EP 1 204 776 B1, EP 1 306 454, EP 1 319 729 A1, WO 99/67435 or WO 00/44949.

The blades or vanes 120, 130 may likewise have coatings protecting against corrosion (MCrAlX; M is at least one element selected from the group consisting of iron (Fe), cobalt (Co), nickel (Ni), X is an active element and stands for yttrium (Y) and/or silicon, scandium (Sc) and/or at least one rare earth element, or hafnium). Alloys of this type are known from EP 0 486 489 B1, EP 0 786 017 B1, EP 0 412 397 B1 or EP 1 306 454 A1.

It is also possible for a thermal barrier coating to be present on the MCrAlX, consisting for example of ZrO₂, Y₂O₃—ZrO₂, i.e. unstabilized, partially stabilized or fully stabilized by yttrium oxide and/or calcium oxide and/or magnesium oxide.

Columnar grains are produced in the thermal barrier coating by suitable coating processes, such as for example electron beam physical vapor deposition (EB-PVD).

The guide vane 130 has a guide vane root (not shown here), which faces the inner housing 138 of the turbine 108, and a guide vane head which is at the opposite end from the guide vane root. The guide vane head faces the rotor 103 and is fixed to a securing ring 140 of the stator 143.

We claim:

1. A process for laser machining, comprising:
traversing a laser beam over the surface of a component that is to be machined a plurality of times,
wherein a second tilt angle of the laser beam with respect to a drilling axis during a subsequent traverse over the surface is different from a first tilt angle with respect to the drilling axis during the first traverse of the surface.

2. The process as claimed in claim 1, wherein the first tilt angle during the first traverse of the laser beam with respect to the drilling axis is not 0°.

3. The process as claimed in claim 2, wherein the first tilt angle is 2°.

4. The process as claimed in claim 1, wherein the surface is traversed a third time by the laser beam.

5. The process as claimed in claim 1, wherein the second tilt angle of the laser beam during the second or following traverse over the surface is increased further each time, in the same tilting direction, with respect to the first or previous traverse.

6. The process as claimed in claim 1, wherein a millisecond laser is used to machine the entire surface or for each pass over the surface.

7. The process as claimed in claim 1, wherein a low energy, in the single-figure joule range, is used for the laser.

8. The process as claimed in claim 7, wherein the range is less than or equal to 4 joules and greater than 1 joule.

9. The process as claimed in claim 8, wherein the energy of the laser is 2 joules.

10. The process as claimed in claim 1, wherein pulsed laser beams are used with pulse durations of 0.1 ms to 0.8 ms.

11. The process as claimed in claim 10, wherein the pulse duration is 0.25 ms.

12. The process as claimed in claim 1, wherein the traverse of the laser beam over the surface in the X direction takes place in rectilinear form.

13. The process as claimed in claim 1,
wherein the surface includes a plurality of sides, and
wherein the machining of the surface by the laser beam always takes place in a direction from a first side toward the opposite side.

14. The process as claimed in claim 13, wherein during the second traverse of the laser beam over the surface the laser beam always starts to machine the surface from the opposite side toward the first side or during the subsequent traverse the laser beam starts to machine the surface only from the first side again, in the X direction.

15. The process as claimed in claim 1, wherein the laser is defocused at the start of the process.

16. The process as claimed in claim 1, wherein the laser is displaced in the Y direction in the middle of the X direction.

17. The process as claimed in claim 1, wherein the process is used to reopen a plurality of coated holes.

18. The process as claimed in claim 17, wherein the coating in the hole is drilled through using the laser prior to the machining of the surface.

19. The process as claimed in claim 1, wherein the process is used to produce a new hole.

20. The process as claimed in claim 1, wherein the laser beam is tilted toward an end side with respect to the drilling axis.
